(19) United States
(12) Patent Application Publication
(10) Pub. No.: US 2023/0316036 A1
(43) Pub. Date: Oct. 5, 2023

(54) Cognitive Artificial Thinking System and Method to Maximize Social Adhesion Between Selected Individuals and Groups of Individuals

(71) Applicant: James Albert Ionson, Lexington, MA (US)

(72) Inventor: James Albert Ionson, Lexington, MA (US)

(21) Appl. No.: 17/712,502

(22) Filed: Apr. 4, 2022

(51) Int. Cl. G06N 3/00; G06N 5/04

(52) U.S. Cl. CPC G06N 3/006; G06N 5/04

(57) ABSTRACT

The disclosed system and method for maximizing social adhesion between selected individuals and groups of individuals utilizes symbolic emotional and intuition-driven architectures combined with inference process algebras such as, but not limited to, cost calculus ($-calculus) which are capable of correlating conciseness and subconscious sensory driven psychological profiles of select individuals and groups of individuals combined with leisure and entertainment venues resulting in “matching” recommendations that maximize social adhesion and minimize social friction.

### RELATED APPLICATIONS

This application claims the benefits of U.S. provisional patent application No. 63/177,801 filed Apr. 21, 2021, which is incorporated herein by reference in its entirety for

The present application is related to U.S. Pat. No. 10,936,959, issued Mar. 2, 2021, for DETERMINING TRUSTWORTHINESS AND COMPATIBILITY OF A PERSON, by Sarabjit Singh Baveja, Anish Das Sarma, and Nilesh Dalvi, included by reference herein.

The present application is related to U.S. Pat. No. 10,868,789, issued Dec. 15, 2020, for SOCIAL MATCHING, by Arvind Mishra, Jonathan Eppers, Gregory Steiner and Joseph Essas, included by reference herein.

The present application is related to U.S. Pat. No. 10,546,326, issued Jan. 28, 2020, for PROVIDING TARGETED CONTENT BASED UPON USERS PREFERENCES, by Mark W. Publicover, William Knight Foster, included by reference herein.

The present application is related to U.S. Pat. No. 10,496,893, issued Dec. 3, 2019, for GENERATING PRODUCT DECISIONS, by Desai Paritosh, Kamal Gajendran, included by reference herein.

The present application is related to U.S. Pat. No. 10,475,056, issued Nov. 12, 2019, for SALES PREDICTION SYSTEMS AND METHODS, by Amanda Kahlow, included by reference herein.

The present application is related to U.S. Pat. No. 10,445,382, issued Oct. 15, 2019, for METHOD AND SYSTEM FOR RELATIONSHIP MANAGEMENT AND INTELLIGENT AGENT, by Geoffrey Hyatt, et. al., included by reference herein.

The present application is related to U.S. Pat. No. 10,411,908, issued Sep. 10, 2019, for INTERACTIVE ADVISORY SYSTEM, by Steven A. Root, Michael R. Root, included by reference herein.

The present application is related to U.S. Pat. No. 10,410,243, issued Sep. 10, 2019, for AUTOMATIC RECOMMENDATION OF DIGITAL OFFERS TO AN OFFER PROVIDER BASED ON HISTORICAL TRANSACTION DATA, by Steven R. Boal, included by reference herein.

The present application is related to U.S. Pat. No. 10,395,275, issued Aug. 27, 2019, for SYSTEM AND METHOD FOR INTERACTIVE MARKETING, by Stephan Randall, et. al., included by reference herein.

The present application is related to U.S. Pat. No. 10,025,835, issued Jul. 17, 2018, for SELECTED MATCHES IN A SOCIAL DATING SYSTEM, by Clifford Lerner, included by reference herein.

The present application is related to U.S. Pat. No. 9,609,072, issued Mar. 28, 2017, for SOCIAL DATING, by Jennifer Jordan Louis and Paul Adams, included by reference herein.

The present application is related to U.S. Pat. No. 9,576,292, issued Feb. 21, 2017, for SYSTEMS AND METHODS TO FACILITATE SELLING OF PRODUCTS AND SERVICES, by Gregg Freishtat et. al., included by reference herein.

The present application is related to U.S. Pat. No. 9,349,098, issued May 25, 2016, for COGNITIVE MEDICAL AND INDUSTRIAL INSPECTION SYSTEM AND METHOD, by James Albert Ionson, included by reference herein.

The present application is related to U.S. Pat. No. 9,336,481 B1, issued May 10, 2016, for ORGANICALLY INSTINCT-DRIVENSIMULATION SYSTEM AND METHOD, by James A. Ionson, included by reference herein.

The present application is related to U.S. Pat. No. 8,856,057, issued Oct. 7, 2014, for COGNITIVE SECURITY SYSTEM AND METHOD, by James A. Ionson, included by reference herein.

The present application is related to U.S. Pat. No. 8,171,032 B2, issued May 1, 2012, for PROVIDING CUSTOMIZED ELECTRONIC INFORMATION, by Frederick S. M. Herz, included by reference herein.

The present application is related to U.S. Pat. No. 8,131,012, issued Mar. 6, 2012, for BEHAVIORAL RECOGNITION SYSTEM, by Eaton, et al., included by reference herein.

The present application is related to U.S. Pat. No. 8,056,100 B2, issued Nov. 8, 2011, for SYSTEM AND METHOD FOR PROVIDING ACCESS TO DATA USING CUSTOMER PROFILES, by Frederick Herz, et. al., included by reference herein.

The present application is related to U.S. Pat. No. 8,001,067 B2, issued Aug. 16, 2011, for METHOD FOR SUBSTITUTING AN ELECTRONIC EMULATION OF THE HUMAN BRAIN INTO AN APPLICATION TO REPLACE A HUMAN, by Thomas A. Visel, Vijay Divar, Lukas K. Womack, Matthew Fettig, Hene P. Hamilton, included by reference herein.

The present application is related to U.S. Pat. No. 7,853,600 B2, issued Dec. 14, 2010, for SYSTEM AND METHOD FOR PROVIDING ACCESS TO VIDEO PROGRAMS AND OTHER DATA USING CUSTOMERS PROFILES, by Frederick Herz, et. al., included by reference herein.

The present application is related to U.S. Pat. No. 7,483,871 B2, issued Jan. 27, 2009, for CUSTOMIZED ELECTRONIC NEWSPAPERS AND ADVERTISEMENTS, by Frederick S. M. Herz, included by reference herein.

The present application is related to U.S. Pat. No. 6,925,441 B1, issued Aug. 2, 2005, for SYSTEM AND METHOD OF TARGETED MARKETING, by Charles L. Jones, III, William A. Eginton, included by reference herein.

The present application is related to United States patent number 20180101866, issued Apr. 12, 2018, for SYSTEM AND METHOD FOR PREFERENCE DETERMINATION, by James Sawczuk, Jeffery French, included by reference herein.

The present application is related to United States patent number 20200051099, issued Feb. 13, 2020, for SALES PREDICTION SYSTEMS AND METHODS, by Amanda Kahiow, included by reference herein.

The present application is related to United States patent number 20170061472, issued Mar. 2, 2017, for DYNAMIC MARKETING ASSET GENERATION BASED ON USER ATTRIBUTES AND ASSET FEATURES, by Craig M. Mathis, included by reference herein.

The present application is related to United States patent number 20200005347, issued Jan. 2, 2020, for AUTOMATIC RECOMMENDATION OF DIGITAL OFFERS TO AN OFFER PROVIDER BASED UPON HISTORICAL TRANSCATION DATA, by Steven R. Boal, included by reference herein.

The present application is related to United States patent number 20160034588, issued Feb. 2, 2016, for METHOD AND SYSTEM FOR RELATIONSHIP MANAGEMENT AND INTELLIGENT AGENT, by Geoffrey Hyatt, included by reference herein.

### OTHER PUBLICATIONS

John E. Lard and Shiwali Mohan, “A Case Study of Knowledge Integration across Multiple Memories in SOAR”, Biologically Inspired Cognitive Architectures, Apr. 2014, 8, pp. 93-99.
Victor C. Hung and Avelino J. Gonzalez, “Towards a Human Behavior Model Based on Instincts”, Prcoeedings of BRIMS, 2007.
D. Canamero, “Modeling Motivations and Emotions as a Basis for Intelligent Behavior”, Prd. First Int. Symp. on Autonomous Agents, AA, The ACM Press, 1997.
A. R. Damasio, “Descartes' Error: Emotion, Reason and the Human Brain Robot”, New York, USA: Picador, 1994.
Eugene Eberbach, “Expressing Evolutionary Computation, Genetic Programming, Artificial Life, Autonomous Agents and DNA-Based Computing in $-Calculus—Revised Version”, August 2013.
Eugene Eberbach, “$-Calculus of Bounded Rational Agents: Flexible Optimization as Search under Bounded Resources in Interactive Systems”, Fundamentalnformaticae 68, 47-102, 2005 Eugene Eberbach, “$-Calculus Bounded Rationality=Process Algebra+Anytime Algorithms”, Applicable Mathematics: Its Perspectives and Challenges, Narosa Publishing House, New Delhi, Mumbai, Calcutta, 532-539, 2001.
Euygen Eberbach and Shashi Phoha, “SAMON: Communication, Cooperation and Learning of Mobile Autonomous Robotic Agents, Proc. of the 11th IEEE. Conf. on Tools with Artificial Intelligence ICTAI′99, Chicago, IL, 229-236, 1999.
Nils Goerke, “EMOBOT: A Robot Control Architecture Based on Emotion-Like Internal Values”, Mobile Robots, Moving Intelligence (ed J. Buchli). ARS/pIV, Germany, 75-94, 2006.
J. D. Velasquez, “When Robots Weep: Emotional Memories and Decision-Making”, Proc. 15th National Conference on Artificial Intelligence, AAAI Press, Madison, Wisconsin, USA, 1997.
M. Salichs and M. Makfaz, “Using Emotions on Autonomous Agents. The Role of Happiness, Sadness and Fear.”, Adaptation in Artificial and Biological Systems (AISB′06), Bristol, England, 157-164, 2006.
John E. Laird, “The SOAR Cognitive Architecture”, MIT Press, May 2012.
Robert P. Marinier III and John E. Laird, “Emotion-Driven Reinforcement Learning”, http://sitemaker.umich.edu/marinier/files/marinier_laird_cogsci_2008_emotionrl.pdf
Ivaylo Popov and Krasimir Popov, “Adaptive Cognitive Method”, USPTO Publication #20140025612, January 2014.
Leonid I. Perlovsky, “Modeling Field Theory of Higher Cognitive Functions”, Chapter III in “Artificial Cognition Systems, Eds. A. Loula, R. Gudwin, J. Queiroz. Idea Group, Hershey, PA, pp. 64-105, 2006.
Leonid I. Perlovsky and R. Kozma., Eds., “Neurodynamics of Higher-Level Cognition and Consciousness”, ISBN 978-3-540-73266-2, Springer-Verlag, Heidelberg, Germany, 2007.
Leonid I. Perlovsky, “Sapience, Consciousness, and the Knowledge Instinct. (Prolegomena to a Physical Theory)”, In Sapient Systems, Eds. Mayorga, R, Perlovsky, L. I., Springer, London, 2007.
Patrick Soon-Shiong, “Reasoning Engines”, USPTO Publication #20140129504, May 2014.
Nikolaos Anastasopoulos, “Systems and Methods for Artificial Intelligence Decision Making in a Virtual Environment”, USPTO Publication #20140279800, September 2014.
Jitesh Dundas and David Chik, “Implementing Human-Like Intuition Mechanism in Artificial Intelligence”, http://www.arxiv.org/abs/1106.5917, Jun. 29, 2011.
Carlos Gershenson, “Behaviour-based Knowledge Systems: An Epigenetic Path from Behaviour to Knowledge”, http://cogprints.org/2320/3/Gershenson-BBKS-Epigenetics.pdf.
Michael D. Byrne, “Cognitive Architectures in HCI: Present Work and Future Directions”, http://chil.rice.edu/research/pdf/Byrne_05.pd.f

### FIELD OF THE INVENTION

The present invention relates generally to machine behavior, and more specifically to the utilization of cognitive processes and technologies such as, but not limited to, cost calculus ($-calculus) which emulate the instinctive, emotional and logical reasoning attributes of highly trained social matching psychologists skilled in maximizing social adhesion and minimizing social friction associated with selected individuals, groups and various leisure and entertainment venues.

### BACKGROUND OF THE INVENTION

The proliferation of social media platforms has resulted in numerous opportunities for selected individuals and groups of individuals to explore mutual interests and desires to engage in social media events with the hope of optimizing social adhesion between select individuals and groups of individuals. There has also been a proliferation of leisure and entertainment venues making it increasing difficult for individuals and groups to align on venue choices that optimize the personal likes and dislikes of these individuals and groups which often are an integration of many diverse cultures, backgrounds and experiences. The providers of these social matching services and associate leisure and entertainment venues make attempts to target their customers with personalized recommendations which are biased towards the merchant and not the customer. This bias often leads to recommendations which do not fill the social adhesion requirements of the customer resulting in frustration and disappointment for both the merchant as well as the customer. Essential all of these “targeted marketing” approaches are based only upon historical buying patterns and search patterns of customers which represent only a limited “like and dislike” profile of targeted customers. There have been recent attempts to incorporate these limited, targeting marketing approaches into algorithmic and digital applications that are usually deployed as mobile and/or desktop computer/Internet applications but the core deficiency related to an incomplete and quite unsophisticated customer profile remains. A few of these systems, methods and application are disclosed in in U.S. Pat. No. 10,936,959, “DETERMINING TRUSTWORTHINESS AND COMPATIBILITY OF A PERSON”, U.S. Pat. No. 10,868,789, “SOCIAL MATCHING”, U.S. Pat. No. 10,025,835, “SELECTED MATCHES IN A SOCIAL DATING SYSTEM”, U.S. Pat. No. 9,609,072, “SOCIAL DATING”, U.S. Pat. No. 6,925,441 B1, “SYSTEM AND METHOD OF TARGETED MARKETING”, U.S. Pat. No. 9,576,292, “SYSTEMS AND METHODS TO FACILITATE SELLING OF PRODUCTS AND SERVICES”, U.S. Pat. No. 8,056,100 B2, “SYSTEM AND METHOD FOR PROVIDING ACCESS TO DATA USING CUSTOMER PROFILES”, USPTO Publication #20200051099, “SALES PREDICTION SYSTEMS AND METHODS”, and USPTO Publication #20200005347, “AUTOMATIC RECOMMENDATION OF DIGITAL OFFERS TO AN OFFER PROVIDER BASED UPON HISTORICAL TRANSACTION DATA”, all incorporated herein by reference in their entirety. Although these disclosures describe semi-automated matching services and products to customers, they are based upon generic profiling of the customers without sufficient granularity to properly ensure social adhesion coupled with effective entertainment venues. Although the customer is offered so-called “perfect matches”, these recommendations are not truly personalized and are biased towards what the merchant wants to sell rather than what the customer actually wants to buy. This deficiency drives customer dissatisfaction and frustration which is not in the best interest of both the merchant and the customer. Even as select individual and group social profiles become more granular and personalized some social matching approaches have incorporated a fixed set of rules manually selected by the users which are used to correlate selected individual, group, leisure and entertainment offerings an attempt to maximize social adhesion. Although these approaches describe an artificial intelligence system to achieve social matching recommendations, they still require the user to manually select “rules” or “requirements” that the user feels are representative of an acceptable “social match”. Although, these limited rule based artificial intelligence systems aid the user in correlating individual, group, entertainment and leisure venues, they still require critical manual inputs from the user regarding “rules and requirement” that may not be compatible with subconscious, subliminal psychological “likes and dislikes” thereby resulting in social matching recommendations that are not fully optimized for maximum social adhesion and minimal social friction. Therefore, there is a need for a fully cognitive artificial thinking social adhesion matching system and method that taps into the important subconscious “likes and dislikes” of individuals and group of individuals that drives a more effective social adhesion matching recommendation.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with the present invention, there is provided a system and method to maximize social adhesion between selected individuals and groups of individuals through use of a fully cognitive artificial thinking social adhesion matching system and method that taps into the important subconscious “likes and dislikes” of individuals and group of individuals thereby driving more effective social adhesion matching recommendations. Effective social adhesion is based upon the sense of sight, touch, hearing, tasting, and smell, all of which have collected raw data over years of a person's lifetime. The human brain processes this data into conscious and subconscious information that drives individual likes and dislikes. In essence our five senses collect data over years of experiences and builds a framework of an individual's social preferences which are integral to ensuring social adhesion between individuals and groups of individuals. Effective social adhesion also requires a granular matching of available leisure and entertainment events and venues which match the social adhesion framework uniquely defined by select individuals and groups of individuals comprising the social group. This invention utilizes symbolic emotional and intuition-driven architectures combined with inference process algebras such as, but not limited to, cost calculus ($-calculus) which are capable of correlating conciseness and subconscious sensory driven psychological profiles of select individuals and groups of individuals combined with leisure and entertainment venues resulting in “matching” recommendations that maximize social adhesion and minimize social friction. The fundamental components of this invention are a software, firmware, hardware and combinations thereof cognitive artificial thinking social adhesion engine which is driven and influenced by psychological internal values correlating personalized social adhesion profiles that reflects the psychological traits driving social behavior patterns including but not limited to likes, dislikes, social compromises within groups as well as group interactive behavior patterns and trends; a software, firmware, hardware and combinations thereof leisure and entertainment venues for providing a database which details characteristics of products and services in a manner that can be correlated with the psychological social adhesion behaviors of individuals and social groups of individuals; a software, firmware, hardware and combinations thereof individual psychological social adhesion correlation module for enabling correlations between individual profiles and group behavior profiles; a software, firmware, hardware and combinations thereof social group adhesion correlation module for correlating individual and group profiles with potential leisure and entertainment venues; a firmware, hardware and combinations thereof leisure and entertainment correlation module for providing overall correlations between gingival, group, leisure and entertainment venues which drive a software, firmware, hardware, and combinations thereof, preliminary matching module which iterates through the cognitive artificial thinking social adhesion engine to provide recommended social matches which maximize social adhesion and minimize social friction among the parties.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates a typical social matching system that is based upon a fixed set of rules manually selected by the users which are used to correlate selected individual, group a, leisure and entertainment venues in an attempt to maximize social adhesion; and

FIG. 2 illustrates the fundamental modules and databases utilized by a cognitive artificial thinking social adhesion system that generates social matches which maximize social adhesion and minimizes social friction.

For purposes of clarity and brevity, like elements and components will bear the same designations and numbering throughout the Figures.

### DESCRIPTION OF THE PREFERRED EMBODIMENT

The problem being addressed relates to matching select individuals and groups of individuals in a manner that maximizes social adhesion among the parties. It is important to distinguish potential discomfort and to eliminate social frictions as a first step. This means not putting an element into the group which can perturb the group or another element of the group which essentially minimizes social friction and maximizes social adhesion. Social adhesion within groups it not always about similar interests which of course is an influencing parameter. Effective social adhesion is based upon the sense of sight, touch, hearing, tasting, and smell, all of which have collected raw data over years of a person's lifetime. The human brain processes this data into conscious and subconscious information that drives individual likes and dislikes. In essence our five senses collect data over years of experiences and builds a framework of an individual's social preferences which are integral to ensuring social adhesion between individuals and groups of individuals. Effective social adhesion also requires a granular matching of available leisure and entertainment events and venues which match the social adhesion framework uniquely defined by select individuals and groups of individuals comprising the social group.

To provide an overall understanding, certain illustrative embodiments will be described; however, it will be understood by one skilled in the art of psychological profiling, data collection and analysis, communication protocols and artificial thinking intelligence technologies that the system and method described can be adapted and modified to provide other suitable applications and that additions and modifications can be made without departing from the scope of the system and method described herein.

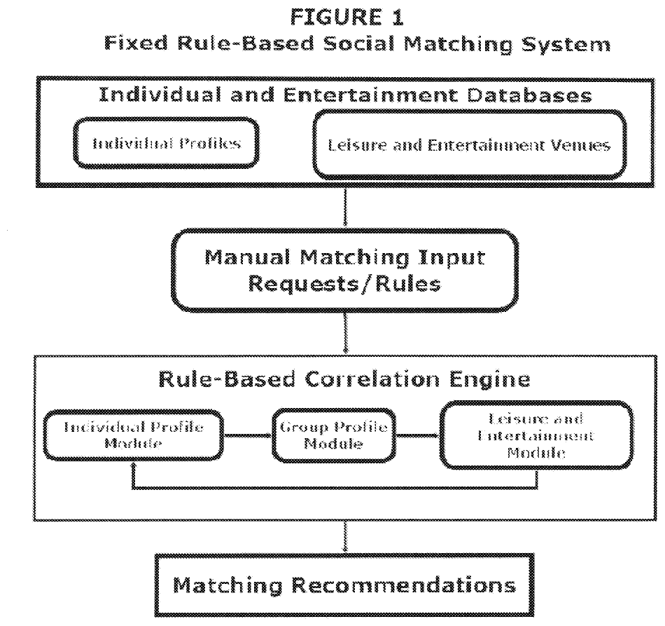

FIG. 1 illustrates a typical social matching system that is based upon a fixed set of rules manually selected by the users which are used to correlate selected individual, group, leisure and entertainment offerings an attempt to maximize social adhesion. Although these approaches describe an artificial intelligence system to achieve social matching recommendations, they still require the user to manually select “rules” or “requirements” that the user feels are representative of an acceptable “social match”. Although, these limited rule based artificial intelligence systems aid the user in correlating individual, group, entertainment and leisure venues, they still require critical manual inputs from the user regarding “rules and requirement” that may not be compatible with subconscious, subliminal psychological “likes and dislikes” thereby resulting in social matching recommendations that are not fully optimized for maximum social adhesion and minimal social friction. Therefore, there is a need for a fully cognitive artificial thinking social adhesion matching system and method that taps into the important subconscious “likes and dislikes” of individuals and group of individuals that drives a more effective social adhesion matching recommendation

This disclosed invention utilizes symbolic emotional and intuition-driven architectures (e.g., “Towards a Human Behavior Model Based on Instinct” which is incorporated herein by reference in its entirety) and inference process algebras such as, but not limited to, cost calculus ($-calculus) (e.g., “Expressing Evolutionary Computation, Genetic Programming, Artificial Life, Agents and DNA-Based Computing in $-Calculus —Revised Version, August 2013”; and “Towards a Human Behavior Model Based on Instinct” which are incorporated herein by reference in their entirety). These algebras and architectures have built-in cost optimization mechanisms allowing them to deal with nondeterminism, incomplete and uncertain information. In particular, $-calculus is a higher-order polyadic process algebra with a “cost” utility function, such as probability that enable agents to emulate human emotion, instincts and logical processing.

The innovative aspect of $-calculus techniques is that they integrate neural networks, symbolic cognitive, emotional and instinct-driven architectures, genetic programming/algorithms, symbolic rule-based expert systems, logic, imperative and object-oriented programming in a common framework (Expressing Evolutionary Computation, Genetic Programming, Artificial Life, Autonomous Agents and DNA-Based Computing in $-Calculus —Revised Version”, August 2013). These techniques have been successfully applied to the Office of Naval research SAMON robotics testbed to derive GBML (Generic Behavior Message-passing Language) for behavior planning, control, and communication of heterogeneous Underwater Vehicles (AUV's) (e.g., SAMON: Communication, Cooperation and Learning of Mobile Robotic Agents which is incorporated herein by reference in its entirety). In addition, $-calculus has also been used in the DARPA Reactive Sensor Networks Project at ARL Penn. State university for empirical cost profiling (e.g., “Reactive Sensor Networks (RSN)” which is incorporated herein by reference in its entirety) with $-calculus expressing all variables as cost expressions: the environment, multiple ommunication/interaction links, inference engines, modified structures, data, code and meta-code. An important feature of this disclosed invention is its internal value system which is designed to operate in accordance with psychological terms that humans associate with “drives” and “emotions”. These internal values do not actually realize real “drives” and “emotions”, but the invention operates in such a way that it exhibits behavior that is governed by “drives” and “emotions” in a manner that simulates the emotional, instinctive, and logical thought processes of highly trained social matching psychologists.

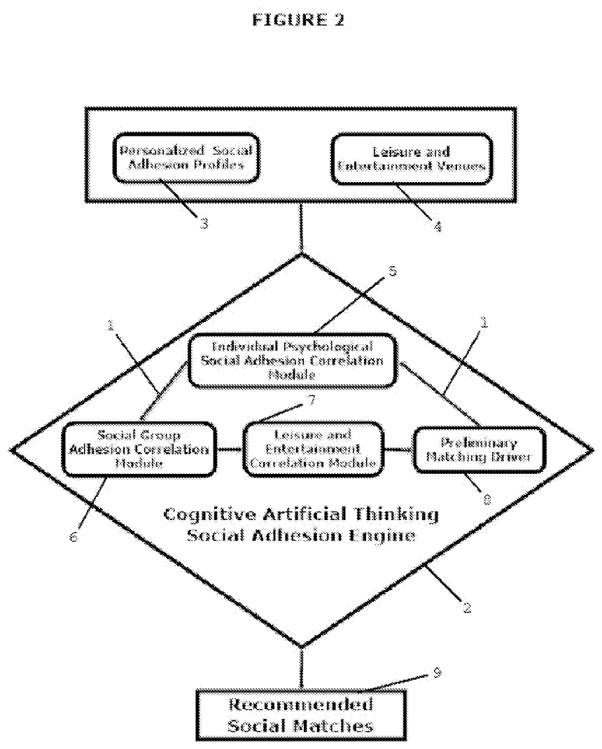

FIG. 2 illustrates the fundamental modules and databases utilized by the disclosed cognitive artificial thinking social adhesion system that generates social matches which maximize social adhesion and minimizes social friction. This disclosed invention utilizes, symbolic emotional and intuition-driven architectures (e.g., “Towards a Human Behavior Model Based on Instinct” which is incorporated herein by reference in its entirety) and inference process algebras such as $-calculus 1 (cost calculus) (e.g., “Expressing Evolutionary Computation, Genetic Programming, Artificial Life, Agents and DNA-Based Computing in $-Calculus—Revised Version”; and “Towards a Human Behavior Model Based on Instinct” which are incorporated herein by reference in their entirety). These algebras and architectures have built-in cost optimization mechanisms allowing them to deal with nondeterminism, incomplete and uncertain information. In particular, $-calculus is a higher-order polyadic process algebra with a “cost” utility function, such as probability that the system to emulate human emotion, instincts and logical processing. The invention also comprises a software, firmware, hardware and combinations thereof cognitive artificial thinking social adhesion engine 2 which is driven and influenced by psychological internal values correlating personalized social adhesion profiles 3 that reflects the psychological traits driving social behavior patterns including but not limited to likes, dislikes, social compromises within groups as well as group interactive behavior patterns and trends; a software, firmware, hardware and combinations thereof leisure and entertainment venues 4 for providing a database which details characteristics of products and services in a manner that can be correlated with the psychological social adhesion behaviors of individuals and social groups of individuals; a software, firmware, hardware and combinations thereof individual psychological social adhesion correlation module 5 for enabling correlations between individual profiles and group behavior profiles; a software, firmware, hardware and combinations thereof social group adhesion correlation module 6 for correlating individual and group profiles with potential leisure and entertainment venues 4; a firmware, hardware and combinations thereof leisure and entertainment correlation module 7 for providing overall correlations between individual, group, leisure and entertainment venues 4 which drive a software, firmware, hardware, and combinations thereof, preliminary matching module 8 which iterates through the cognitive artificial thinking social adhesion engine 2 to provide recommended social matches 9 which maximize social adhesion and minimize social friction among the parties.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A cognitive artificial thinking system and method to maximize social adhesion between selected individuals and groups of individuals for enabling advanced cognitive processes and technologies which emulate emotion, instinct and logical reasoning thereby optimizing personal matching processes and methods that are based upon sensory driven psychological profiling of selected individuals and groups of individuals, comprising:
means for utilizing mathematical techniques of cost calculus ($calculus), inference process algebras and emotional cognitive architectures that emulate the instinctive, emotional and logical reasoning of those highly trained in human behavior and social adhesion;
means for creating a highly personalized database that comprises sensory driven psychological traits which define social adhesion including but not limited to likes, dislikes, social compromises within groups as well as group interactive behavior patterns and trends;
means for providing a database which details characteristics of leisure and entertainment products and services in a manner that can be correlated with the psychological social adhesion profiles and behaviors of selected individuals and groups of individuals;
means for enabling highly personalized individual social adhesion profiles to be correlated with social group behavior profiles;
means for enabling social group behavior profiles to be correlated with individual psychological social adhesion profiles combined with potential leisure and entertainment venues;
means for targeting data that can be correlated with users' social adhesion profiles, available leisure and entertainment products and services and user requests for social adhesion event recommendations; utilizing techniques such as, but not limited to tracking patterns, classification, association, outlier detection and clustering;
means for enabling a preliminary social adhesion match between selected individuals, groups and associated leisure and entertainment venues; and
means for providing individual, group, leisure and entertainment matching recommendations that maximize social adhesion and minimize social friction.

2. The cognitive artificial thinking system and method to maximize social adhesion between selected individuals and groups of individuals in accordance with claim 1, wherein said means for utilizing mathematical techniques of cost calculus ($calculus), inference process algebras and emotional cognitive architectures that emulate the instinctive, emotional and logical reasoning of those highly trained in human behavior and social adhesion comprises a software, hardware, firmware and combinations thereof cognitive artificial thinking social adhesion engine.

3. The cognitive artificial thinking system and method to maximize social adhesion between selected individuals and groups of individuals in accordance with claim 1, wherein said means for creating a highly personalized database that comprises sensory driven psychological traits which define social adhesion including but not limited to likes, dislikes, social compromises within groups as well as group interactive behavior patterns and trends comprises a software, firmware, hardware and combinations thereof personalized social adhesion profiles.

4. The cognitive artificial thinking system and method to maximize social adhesion between selected individuals and groups of individuals in accordance with claim 1, wherein said means for providing a database which details characteristics of leisure and entertainment products and services in a manner that can be correlated with the psychological social adhesion profiles and behaviors of selected individuals and groups of individuals comprises a software, firmware, hardware and combinations thereof leisure and entertainment venues.

5. The cognitive artificial thinking system and method to maximize social adhesion between selected individuals and groups of individuals in accordance with claim 1, wherein said means for enabling highly personalized individual social adhesion profiles to be correlated with social group behavior profiles comprises a software, firmware, hardware and combinations thereof individual psychological social adhesion correlation module.

6. The cognitive artificial thinking system and method to maximize social adhesion, between selected individuals and groups of individuals in accordance with claim 1, wherein said means for enabling social group behavior profiles to be correlated with individual psychological social adhesion profiles combined with potential leisure and entertainment venues comprises a software, firmware, hardware and combinations thereof social group adhesion correlation module.

7. The cognitive artificial thinking system and method to maximize social adhesion between selected individuals and groups of individuals in accordance with claim 1, wherein said means for targeting data that can be correlated with users' social adhesion profiles, available leisure and entertainment products and services and user requests for social adhesion event recommendations; utilizing techniques such as, but not limited to tracking patterns, classification, association, outlier detection and clustering comprises a software, firmware, hardware and combinations thereof leisure and entertainment correlation module.

8. The cognitive artificial thinking system and method to maximize social adhesion between selected individuals and groups of individuals in accordance with claim 1, wherein said means for enabling a preliminary social adhesion match between selected individuals, groups and associated leisure and entertainment venues comprises a software, firmware, hardware and combinations thereof preliminary matching module.

9. The cognitive artificial thinking system and method to maximize social adhesion between selected individuals and groups of individuals in accordance with claim 1, wherein said means for providing individual, group, leisure and entertainment matching recommendations that maximize social adhesion and minimize social friction comprises a software, hardware, firmware and combinations thereof recommended social matches.

10. A cognitive artificial thinking system and method to maximize social adhesion between selected individuals and groups of individuals for enabling advanced cognitive processes and technologies which emulate emotion, instinct and logical reasoning thereby optimizing personal matching processes and methods that are based upon sensory driven psychological profiling of selected individuals and groups of individuals, comprising:
a software, hardware, firmware and combinations thereof cognitive artificial thinking social adhesion engine, for utilizing mathematical techniques of cost calculus ($calculus), inference process algebras and emotional cognitive architectures that emulate the instinctive, emotional and logical reasoning of those highly trained in human behavior and social adhesion;
a software, firmware, hardware and combinations thereof personalized social adhesion profiles, for creating a highly personalized database that comprises sensory driven psychological traits which define social adhesion including but not limited to likes, dislikes, social compromises within groups as well as group interactive behavior patterns and trends;
a software, firmware, hardware and combinations thereof leisure and entertainment venues, for providing a database which details characteristics of leisure and entertainment products and services in a manner that can be correlated with the psychological social adhesion profiles and behaviors of selected individuals and groups of individuals;
a software, firmware, hardware and combinations thereof individual psychological social adhesion correlation module, for enabling highly personalized individual social adhesion profiles to be correlated with social group behavior profiles;
a software, firmware, hardware and combinations thereof social group adhesion correlation module, for enabling social group behavior profiles to be correlated with individual psychological social adhesion profiles combined with potential leisure and entertainment venues;
a software, firmware, hardware and combinations thereof leisure and entertainment correlation module, for targeting data that can be correlated with users' social adhesion profiles, available leisure and entertainment products and services and user requests for social adhesion event recommendations; utilizing techniques such as, but not limited to tracking patterns, classification,
association, outlier detection and clustering;
a software, firmware, hardware and combinations thereof preliminary matching module, for enabling a preliminary social adhesion match between selected individuals, groups and associated leisure and entertainment venues; and
a software, hardware, firmware and combinations thereof recommended social matches, for providing individual, group, leisure and entertainment matching recommendations that maximize social adhesion and minimize social friction.

11. The cognitive artificial thinking system and method to maximize social adhesion between selected individuals and groups of individuals as recited in claim 10, further comprising:
a software, hardware, firmware and combinations thereof inference process algebras such as $-calculus, for analyzing and performing correlations of data in a manner that emulates the instinctive, emotional and logical reasoning attributes of highly trained match making psychologists.

12. A cognitive artificial thinking system and method to maximize social adhesion between selected individuals and groups of individuals for enabling advanced cognitive processes and technologies which emulate emotion, instinct and logical reasoning thereby optimizing personal matching processes and methods that are based upon sensory driven psychological profiling of selected individuals and groups of individuals, comprising:
a software, hardware, firmware and combinations thereof inference process algebras such as $-calculus, for analyzing and performing correlations of data in a manner that emulates the instinctive, emotional and logical reasoning attributes of highly trained match making psychologists;
a software, hardware, firmware and combinations thereof cognitive artificial thinking social adhesion engine, for utilizing mathematical techniques of cost calculus ($calculus), inference process algebras and emotional cognitive architectures that emulate the instinctive, emotional and logical reasoning of those highly trained in human behavior and social adhesion;
a software, firmware, hardware and combinations thereof personalized social adhesion profiles, for creating a highly personalized database that comprises sensory driven psychological traits which define social adhesion including but not limited to likes, dislikes, social compromises within groups as well as group interactive behavior patterns and trends;
a software, firmware, hardware and combinations thereof leisure and entertainment venues, for providing a database which details characteristics of leisure and entertainment products and services in a manner that can be correlated with the psychological social adhesion profiles and behaviors of selected individuals and groups of individuals;
a software, firmware, hardware and combinations thereof individual psychological social adhesion correlation module, for enabling highly personalized individual social adhesion profiles to be correlated with social group behavior profiles;
a software, firmware, hardware and combinations thereof social group adhesion correlation module, for enabling social group behavior profiles to h correlated with individual psychological social adhesion profiles combined with potential leisure and entertainment venues;
a software, firmware, hardware and combinations thereof leisure and entertainment correlation module, for targeting data that can be correlated with users' social adhesion profiles, available leisure and entertainment products and services and user requests for social adhesion event recommendations; utilizing techniques such as, but not limited to tracking patterns, classification,
association, outlier detection and clustering;
a software, firmware, hardware and combinations thereof preliminary matching module, for enabling a preliminary social adhesion match between selected individuals, groups and associated leisure and entertainment venues; and
a software, hardware, firmware and combinations thereof recommended social matches, for providing individual, group, leisure and entertainment matching recommendations that maximize social adhesion and minimize social friction.
